(19) United States
(12) Patent Application Publication
(10) Pub. No.: US 2026/0169863 A1
(43) Pub. Date: Jun. 18, 2026

(54) AUTOMATIC CREATION OF BACKUP ENTITIES

(71) Applicant: Rubrik, Inc., Palo Alto, CA (US)

(72) Inventors: Grace QI, Cupertino, CA (US); Abhishek DHARMAPURIKAR, San Jose, CA (US); Devanshu KOYALKAR, Toronto (CA); Gaurav KHANDELWAL, San Jose, CA (US)

(21) Appl. No.: 18/984,986

(22) Filed: Dec. 17, 2024

(51) Int. Cl. G06F 11/14

(52) U.S. Cl. CPC G06F 11/1461; G06F 2201/80

(57) ABSTRACT

Methods, systems, and devices for data management are described. The method may include detecting, by a backup system, a new source entity at a host computing environment defining a set of resources at the host computing environment, the backup system storing multiple backup entities associated with respective sets of resources at the host computing environment and configured to support backup of the respective sets of resources; determining, after detecting the new source entity, that the new source entity is unassociated with a current backup entity of the multiple backup entities; generating, a new backup entity for the new source entity, the new backup entity configured to support backup of the set of resources at the host computing environment; and obtaining, in accordance with a backup schedule associated with the new backup entity, a backup of the set of resources at the host computing environment.

### FIELD OF TECHNOLOGY

The present disclosure relates generally to data management, including techniques for automatic creation of backup entities.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports automatic creation of backup entities in accordance with aspects of the present disclosure.

FIG. 2 shows an example of a computing architecture that supports automatic creation of backup entities in accordance with aspects of the present disclosure.

FIG. 3 shows an example of a process flow that supports automatic creation of backup entities in accordance with aspects of the present disclosure.

FIG. 4 shows a block diagram of an apparatus that supports automatic creation of backup entities in accordance with aspects of the present disclosure.

FIG. 5 shows a block diagram of a backup entity manager that supports automatic creation of backup entities in accordance with aspects of the present disclosure.

FIG. 6 shows a diagram of a system including a device that supports automatic creation of backup entities in accordance with aspects of the present disclosure.

FIGS. 7 through 9 show flowcharts illustrating methods that support automatic creation of backup entities in accordance with aspects of the present disclosure.

### DETAILED DESCRIPTION

Some host computing environments utilize computing clusters to support and execute applications. Cluster based systems may use a named logical entity (e.g., a source entity) which is a high-level organizational construct that allows a user to partition or divide the resources in a cluster into separate areas. A source entity may be a logical entity used to represent cluster resources (e.g., deployments, pods, replica sets) for usage of a particular set of users. A backup system may support backup of source clusters. A backup system may define a backup entity, which defines what resources are subject to or protected by a backup. The backup entity may define the resources using filters or labels. When a source computing system is onboarded to a backup system, an administrator has to define the various backup entities, which may be defined at the source entity level. However, a single computing cluster may have hundreds of source entities. Thus, the process of setting up backups may be cumbersome for users and for systems.

Techniques for automatic creation of backup entities at the backup system are described herein. The backup system executes a periodic (or on-demand) refresh job that detects new source entities in the source computing cluster. New source computing entities are added to a backup entity database table at the backup system. If a new source entity is not associated with a current backup entity, then a new backup entity is created for the new source entity. The source entity associated with the new backup entity will be protected (backed-up) by default based on a service level agreement (SLA) (e.g., backup schedule) associated with the cluster, but the user can assign a custom SLA to any backup entity. If a source entity is already associated with a backup entity, then a new backup entity is not created based on the assumption that the customer has already configured desired backup solutions for the source entity. The name of the backup entity set will be based on the name of the source entity, and the new backup entity may be defined based on the all of the protectable resources in the source entity. The backup system also performs an archival operation when a source entity gets deleted at the source. A controller/agent associated with the backup system detects namespace deletions and notifies the backup system. The backup system then deletes the backup entity (e.g., the protection set). These and other techniques are described in further detail with respect to the figures.

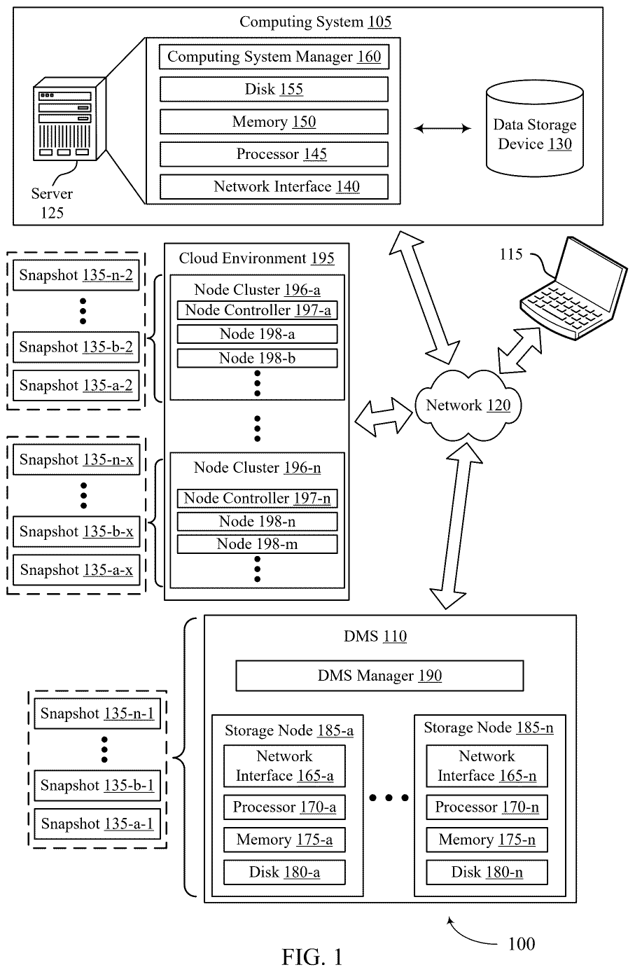

FIG. 1 illustrates an example of a computing environment 100 that supports automatic creation of backup entities in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state-which may be referred to as the delta-of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110, the cloud environment 195, or both may create and define backup objects (e.g., backup entities) for sets of resources at the computing system 105 that are to be backed up. Each set of resources may be referred to as a snappable. In some cases, the computing system 105 is a cluster based computing system, such as a Kubernetes cluster, and the cluster based computing system may define logical entities (e.g., source entities or namespaces) that are used for various services. Each logical entity may include a set of resources (e.g., pods). A backup object may be used to manage backup of each of the logical entities. However, creation of backup objects for each logical entity may be resource intensive, and the computing system 105 may include hundreds of logical entities, which may result in significant resource and user overhead. Techniques described herein support the automatic creation of backup entities at the backup system (e.g., DMS 110 and/or cloud environment 195) after detection of new logical entities at the computing system 105.

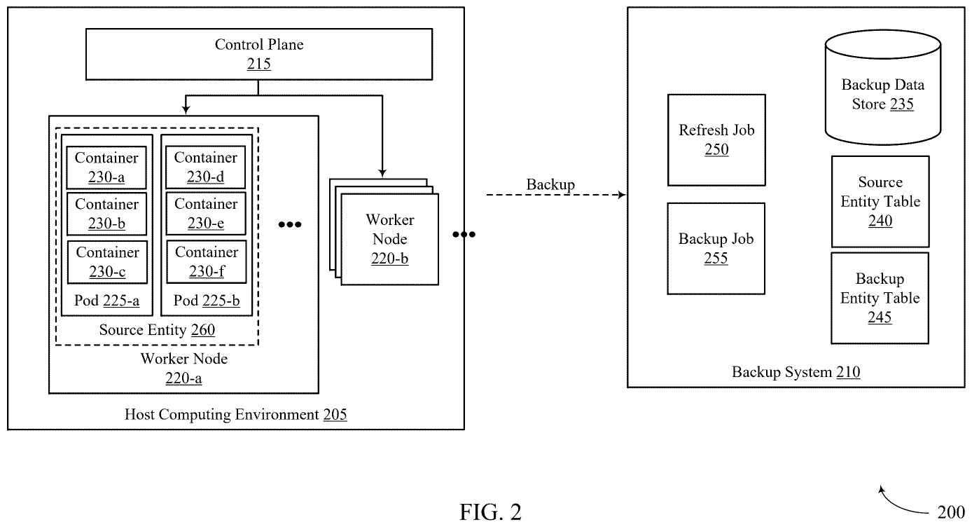

FIG. 2 shows an example of a computing architecture 200 that supports automatic creation of backup entities in accordance with aspects of the present disclosure. The computing architecture 200 includes a host computing environment 205 and a backup system 210. The host computing environment 205 may be an example of the computing system 105 of FIG. 1, and the backup system 210 may be an example of aspects of the DMS 110, the cloud environment 195, or both of FIG. 1. The backup system 210 may provide backup services for resources of the host computing environment 205, as described herein.

In some cases, the host computing environment 205 is an example of a cluster based computing system (e.g., Kubernetes), and the host computing environment 205 may be an example of a cluster that includes multiple machines (e.g., nodes, such as worker nodes 220) that run containerized applications. The cluster (e.g., the host computing environment 205) may include a control plane, which may be an example of a master node, which controls the cluster such as by scheduling applications on containers 230 of worker nodes 220. Each of the nodes, such as the worker nodes 220 and the control plane 215, may be examples of individual machines (e.g., physical or virtual) in the cluster, and each node may include one or more pods 225 that execute one or more containers 230. The one or more pods 225 include one or more containers 230 that share the same network namespace, allowing the containers 230 to communicate. The containers 230 may be examples of lightweight, standalone packages that includes code, runtime, system tools, libraries, and settings for packing and executing applications. The containers 230 within the pods 225 may share the same IP address, port space, and storage volume, such as to provide data persistence and data sharing. These storage volumes may persist data so that the data may be used by other containers within the pods.

The host computing environment 205 may provide techniques to divide resources of the environment 205 between multiple users and teams. For example, the host computing environment 205 may support source entities (e.g., namespaces), such as source entity 260, that provide a mechanism for isolating groups of resources within a single cluster. Namespaces or source entities may be used in environments with many users spread across multiple teams or projects, where resource isolation may be beneficial. The source entities may support creation of multiple virtual clusters within a single physical clusters, and the source entities may define resource sets such that pods, services, and deployments may be logically grouped together and isolated from resources in other source entities.

As illustrated in FIG. 2, the host computing environment 205 includes the source entity 260, which includes the pod 225-a and the pod 225-b of the worker node 220-a. It should be understood that source entities (e.g., namespaces) may encapsulate different types of resources of the host computing environment 205. For example, a source entity may include pods from multiple worker nodes 220. As described herein, the source entities may provide a way to logically divide cluster resources between different users, teams, or projects, and function as virtual clusters with their own scope for resource names.

The backup system 210 may support backup services for one or more host computing environments, such as host computing environment 205. A user may access the backup system 210 to create and utilize backup entities at the backup system. A backup entity (e.g., protection set) may be associated with a set of resources at the host computing environment 205 and may be used to manage backup of the associated set of resources. The backup entity may be referred to as a snappable, and may correspond to a subset of resources within a source entity or namespace. The backup entity may be used to perform recovery operations for the corresponding set of resource, device backup schedule for the corresponding set of resource, to implement resource filtering, etc. at the backup system 210. In some cases, a user may be required to create a backup entity for each set of resource at the host computing environment 205 to be backed up. However, the host computing environment 205 may include hundreds of sets of resources, where each set of resources is defined by a source entity or namespace. As such, creation of a backup entity for each set of resources may be cumbersome and resource intensive. Additionally, if no backup entity is created for a set of resources at the host computing environment 205, then the set of resources may not be backed up. With no corresponding backup, the resources are subject to loss due to a computing fault, crash, outage, bug, downtime, or the like.

Techniques described herein support the automated creation of backup entities at the backup system 210 for source entities at the host computing environment 205. The backup system 210 may execute a periodic or on-demand refresh job 250 that performs various operations such as calculating when backups are to be performed (e.g., based on backup schedules or SLAs), fetching information from the host computing environment 205, deploying resources on the host computing environment 205, synchronizing objects with the host computing environment 205, or a combination thereof. One or more of these operations may allow the backup job 255 to detect new source entities 260 within the host computing environment 205. Additionally, to support the techniques described herein, the refresh job 250 may also be configured to create new backup entities at the backup system 210 after detection of new source entities 260 within the host computing environment 205.

Thus, after detecting source entities at the host computing environment 205, the refresh job 250 may fetch a list of source entities documented at the backup system 210 via a source entity table 240. The refresh job 250 may also fetch a list of previously and automatically created backup entities from a backup entity table 245. The source entity table 240 and the backup entity table 245 may be examples of database tables that are used to document the backup entities and the source entities, respectively. After fetching the respective lists, the refresh job 250 may create new backup entities for source entities that are not already associated with backup entities. That is, the backup system may determine that a source entity is unassociated with a current backup entity at the backup system 210 and generate a new backup entity for the source entity. The new backup entity may support backup of the resources of the source entity.

In some cases, generation of the new backup entity may include adding an entry to the backup entity table 245, and the entry may include information that maps the resources of the source entity to the backup entity. After creation of the backup entity, the resource of the source entity may be backed up in accordance with a backup schedule associated with the new backup entity. The backup may be performed by a backup job 255. In some cases, the backup schedule may be a default backup schedule (e.g., SLA) associated with the host computing environment 205. When a backup is triggered based on the backup schedule, the backup system 210 may obtain the data of the resources to be backed up and store the data in a backup data store 235, which may be a local data store, a cloud based data store, or a combination thereof. The backup entity table 245 may include a field or column that specifies the corresponding type of backup entities. Thus, backup entities that are automatically created in accordance with the techniques described herein may include a field with a value (e.g., “auto”) that specifies that the backup entity was automatically created. Additionally, as a default, the name of the automatically created backup entities may be configured as the name or identifier of the source entity at the host computing environment 205.

In some cases, the automatic creation of backup entities may be enabled based on user input. For example, a user may access a user interface (UI) supported by the backup system 210 and activate a UI component (e.g., a check box) to activate automatic generation of backup entities. Additionally, after automatic creation of the backup entity, the user may access the UI and adjust configurations of the automatically generated backup entity. For example, the user may adjust or assign the backup schedule (e.g., SLA) associated with the automatically generated protection set, adjust the name, etc. Additionally, or alternatively, the user may adjust the resources in the set of resources that are backed up via the backup entity. That is, the user may selectively disable one or more resources from being backed up by the backup entity. In some cases, the user may apply a filter that filters types of resources from being backed up by the backup entity.

In some cases, the backup system 210 may implement an archival job that archives backup entities. For example, the refresh job 250 may detect that a source entity that is associated with a backup entity no longer exists at the host computing environment 205. In such cases, the backup system 210 may delete the backup entity from the backup entity table 245. However, the backup system 210 may not delete corresponding backups for the source entity, as the backups may be used for restoring the source entity at a later time.

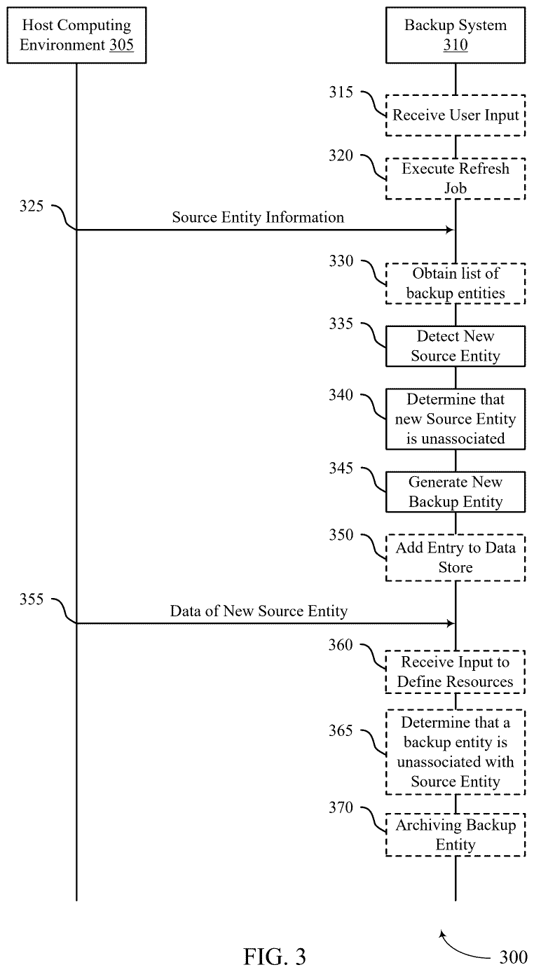

FIG. 3 shows an example of a process flow 300 that supports automatic creation of backup entities in accordance with aspects of the present disclosure. The process flow 300 includes a host computing environment 305 and a backup system 310. The host computing environment 305 may be an example of the host computing environment 205 of FIG. 2 or the computing system 105 of FIG. 1. The backup system 310 may be an example of the backup system 210 of FIG. 2 or the DMS 110 or the cloud environment 195 of FIG. 1. In the following description of the process flow 300, the operations between the host computing environment 305 and the backup system 310 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 315, the backup system 310 may receive, at a user interface of the backup system 310, a user input that enables generation of new backup entities for new source entities. For example, the user may activate a checkbox associated with automatic generation of new backup entities.

At 320, the backup system may execute a refresh job associated with the host computing environment 305. The refresh job may be executed on-demand (e.g., based on user input) or based on a schedule. For example, the backup system 310 may be configured to execute the refresh job at a 20 minute cadence. At 325, as part of the refresh job, the backup system 310 may receive source entity information, among other information, from the host computing environment 305. At 330, the backup system 310 may obtain, from a data store, a list of a backup entities at the backup system 310.

At 335, the backup system 310 may detect a new source entity (e.g., a new namespace) at the host computing environment 305, where the new source entity defines a set of resources at the host computing environment 305. The backup system 310 may store multiple backup entities associated with respective sets of resources at the host computing environment 305, and each of the backup entities may be configured to support backup of the respective sets of resources at the host computing environment 305. In some cases, the host computing environment 305 is a cluster of computing nodes (e.g., a Kubernetes cluster) that support one or more containerized applications. In such cases, the new source entity is a new namespace at the cluster of computing nodes. At 340, to detect the new source entity is new, the backup system 310 may determine that the new source entity is unassociated with a current backup entity of the multiple backup entities at the backup system 310. In some cases, determining that the new source entity is unassociated may include determining that an identifier for the new source entity is absent from the list of backup entities.

At 345, the backup system 310 may generate a new backup entity for the new source entity, where the new backup entity is configured to support backup of the set of resources at the host computing environment 305 and defined by the new source entity. In some cases, generation of the new backup entity may include, at 350, adding, to a data store (e.g., backup entity table) including a list of the multiple backup entities, an entry with an indication of the new backup entity, where the entry includes information indicating that the new backup entity is generated based on detection of the new source entity. In some cases, the entry includes a name of the new backup entity, where the name is generated based on an identifier of the source entity at the host computing environment 305.

At 355, the backup system 310 may obtain, in accordance with a backup schedule associated with the new backup entity, a backup of the set of resources at the host computing environment 305. The backup system 310 may store the data in a backup data store. At 360, the backup system 310 may receive, at a user interface, one or more user inputs that define one or more resources of the set of resources of the new source entity. In such cases, a subsequent backup may obtain backup of data of the one or more resources based on the user input.

At 365, the backup system 310 may determine that a backup entity of the multiple backup entities is unassociated with an existing source entity at the host computing environment. For example, the backup system may detect that the backup entity has no existing source entity at the host computing environment. For example, the corresponding source entity may be deleted from the host computing environment 305. In such cases, at 370, the backup system 310 may archive based on determining that the backup entity is unassociated with an existing source entity, the backup entity without deleting a second backup associated with the backup entity.

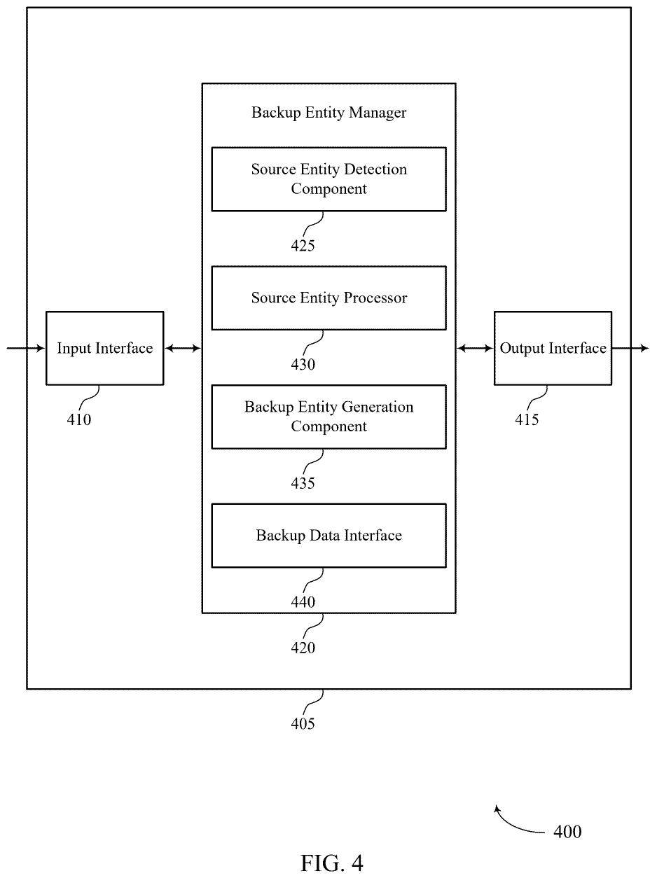

FIG. 4 shows a block diagram 400 of a system 405 that supports automatic creation of backup entities in accordance with aspects of the present disclosure. In some examples, the system 405 may be an example of aspects of one or more components described with reference to FIG. 1, such as a DMS 110. The system 405 may include an input interface 410, an output interface 415, and a backup entity manager 420. The system 405 may also include one or more processors. Each of these components may be in communication with one another (e.g., via one or more buses, communications links, communications interfaces, or any combination thereof).

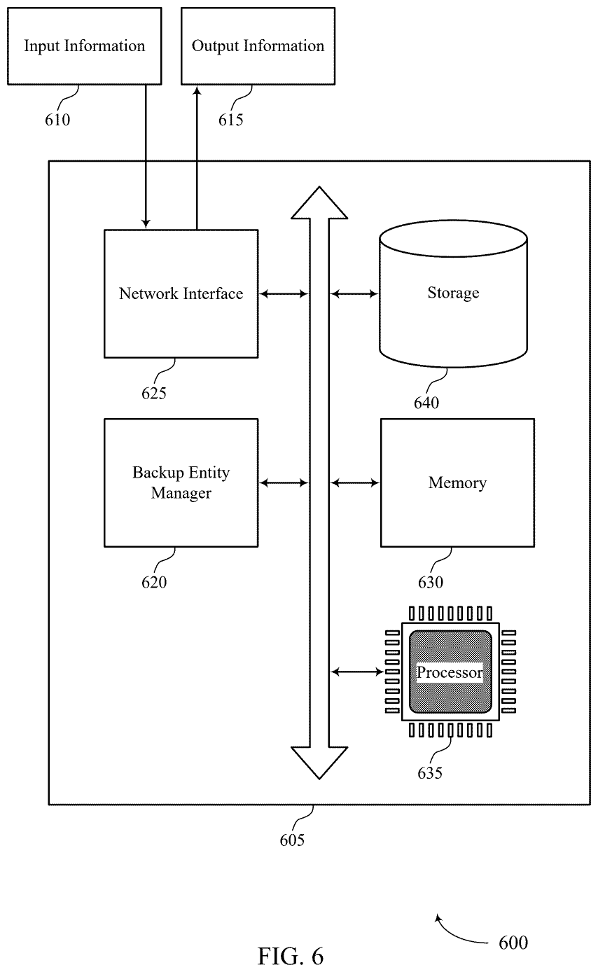

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the backup entity manager 420 to support automatic creation of backup entities. In some cases, the input interface 410 may be a component of a network interface 625 as described with reference to FIG. 6.

The output interface 415 may manage output signaling for the system 405. For example, the output interface 415 may receive signaling from other components of the system 405, such as the backup entity manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the backup entity manager 420 may include a source entity detection component 425, a source entity processor 430, a backup entity generation component 435, a backup data interface 440, or any combination thereof. In some examples, the backup entity manager 420, or various components thereof, may be configured to perform various operations (e.g., receiving, monitoring, transmitting) using or otherwise in cooperation with the input interface 410, the output interface 415, or both. For example, the backup entity manager 420 may receive information from the input interface 410, send information to the output interface 415, or be integrated in combination with the input interface 410, the output interface 415, or both to receive information, transmit information, or perform various other operations as described herein.

The source entity detection component 425 may be configured as or otherwise support a means for detecting, by a backup system, a new source entity at a host computing environment defining a set of resources at the host computing environment, the backup system storing a set of multiple backup entities associated with respective sets of resources at the host computing environment and configured to support backup of the respective sets of resources at the host computing environment. The source entity processor 430 may be configured as or otherwise support a means for determining, after detecting the new source entity, that the new source entity is unassociated with a current backup entity of the set of multiple backup entities. The backup entity generation component 435 may be configured as or otherwise support a means for generating, at the backup system, a new backup entity for the new source entity, the new backup entity configured to support backup of the set of resources at the host computing environment and defined by the new source entity. The backup data interface 440 may be configured as or otherwise support a means for obtaining, in accordance with a backup schedule associated with the new backup entity, a backup of the set of resources at the host computing environment.

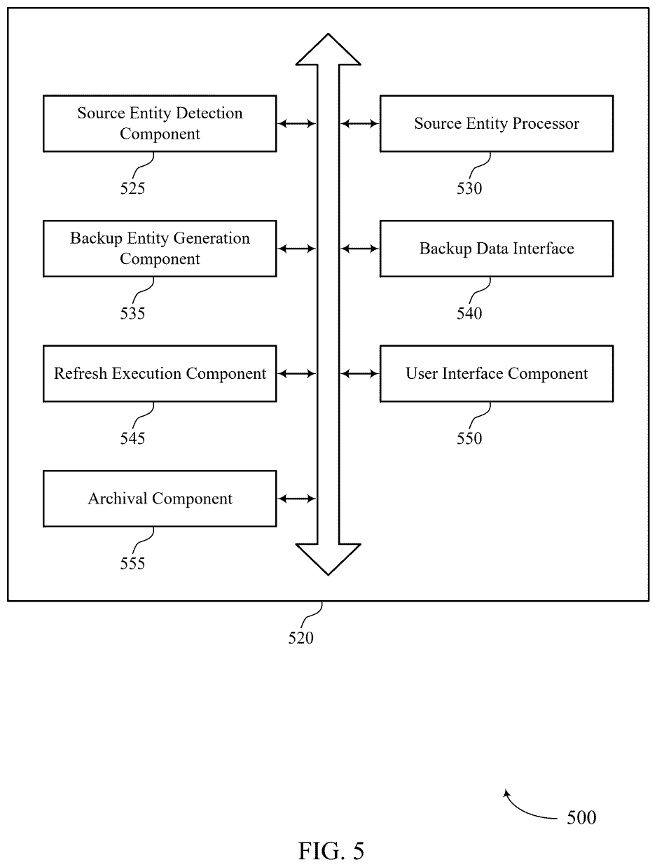

FIG. 5 shows a block diagram 500 of a backup entity manager 520 that supports automatic creation of backup entities in accordance with aspects of the present disclosure. The backup entity manager 520 may be an example of aspects of a backup entity manager or a backup entity manager 420, or both, as described herein. The backup entity manager 520, or various components thereof, may be an example of means for performing various aspects of automatic creation of backup entities as described herein. For example, the backup entity manager 520 may include a source entity detection component 525, a source entity processor 530, a backup entity generation component 535, a backup data interface 540, a refresh execution component 545, a user interface component 550, an archival component 555, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The source entity detection component 525 may be configured as or otherwise support a means for detecting, by a backup system, a new source entity at a host computing environment defining a set of resources at the host computing environment, the backup system storing a set of multiple backup entities associated with respective sets of resources at the host computing environment and configured to support backup of the respective sets of resources at the host computing environment. The source entity processor 530 may be configured as or otherwise support a means for determining, after detecting the new source entity, that the new source entity is unassociated with a current backup entity of the set of multiple backup entities. The backup entity generation component 535 may be configured as or otherwise support a means for generating, at the backup system, a new backup entity for the new source entity, the new backup entity configured to support backup of the set of resources at the host computing environment and defined by the new source entity. The backup data interface 540 may be configured as or otherwise support a means for obtaining, in accordance with a backup schedule associated with the new backup entity, a backup of the set of resources at the host computing environment.

In some examples, the refresh execution component 545 may be configured as or otherwise support a means for executing, at the backup system, a refresh job, where execution of the refresh job results in detection of the new source entity at the host computing environment.

In some examples, to support determining that the new source entity is unassociated with the current backup entity, the source entity processor 530 may be configured as or otherwise support a means for obtaining, from a data store, a list of the set of multiple backup entities. In some examples, to support determining that the new source entity is unassociated with the current backup entity, the source entity processor 530 may be configured as or otherwise support a means for determining that the new source entity is absent from the list of the set of multiple backup entities.

In some examples, to support generating the new backup entity, the backup entity generation component 535 may be configured as or otherwise support a means for adding, to a data store including a list of the set of multiple backup entities, an entry with an indication of the new backup entity, where the entry includes information indicating that the new backup entity is generated based on detection of the new source entity.

In some examples, the entry includes a name for the new backup entity. In some examples, the name is generated based on an identifier for the new source entity.

In some examples, the backup schedule associated with the new backup entity is a default backup schedule associated with the host computing environment.

In some examples, the user interface component 550 may be configured as or otherwise support a means for receiving, at a user interface of the backup system, a user input that enables generation of new backup entities for new source entities, where the new backup entity is generated based on the user input.

In some examples, the user interface component 550 may be configured as or otherwise support a means for receiving, at a user interface of the backup system, one or more user inputs that define one or more resources of the set of resources of the new source entity, where the backup is obtained for the one or more resources that are defined by the one or more user inputs.

In some examples, the archival component 555 may be configured as or otherwise support a means for determining that a backup entity of the set of multiple backup entities is unassociated with an existing source entity at the host computing environment. In some examples, the archival component 555 may be configured as or otherwise support a means for archiving, based on determining that the backup entity is unassociated with an existing source entity, the backup entity without deleting a second backup associated with the backup entity.

In some examples, the host computing environment includes a cluster of computing nodes that support one or more containerized applications and. In some examples, the new source entity includes a new namespace at the cluster of computing nodes.

FIG. 6 shows a block diagram 600 of a system 605 that supports automatic creation of backup entities in accordance with aspects of the present disclosure. The system 605 may be an example of or include components of a system 405 as described herein. The system 605 may include components for data management, including components such as a backup entity manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting automatic creation of backup entities). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the backup entity manager 620 may be configured as or otherwise support a means for detecting, by a backup system, a new source entity at a host computing environment defining a set of resources at the host computing environment, the backup system storing a set of multiple backup entities associated with respective sets of resources at the host computing environment and configured to support backup of the respective sets of resources at the host computing environment. The backup entity manager 620 may be configured as or otherwise support a means for determining, after detecting the new source entity, that the new source entity is unassociated with a current backup entity of the set of multiple backup entities. The backup entity manager 620 may be configured as or otherwise support a means for generating, at the backup system, a new backup entity for the new source entity, the new backup entity configured to support backup of the set of resources at the host computing environment and defined by the new source entity. The backup entity manager 620 may be configured as or otherwise support a means for obtaining, in accordance with a backup schedule associated with the new backup entity, a backup of the set of resources at the host computing environment.

By including or configuring the backup entity manager 620 in accordance with examples as described herein, the system 605 may support techniques for automatic creation of backup entities, which may provide one or more benefits such as, for example, improved user experience and more efficient utilization of computing resources, among other possibilities.

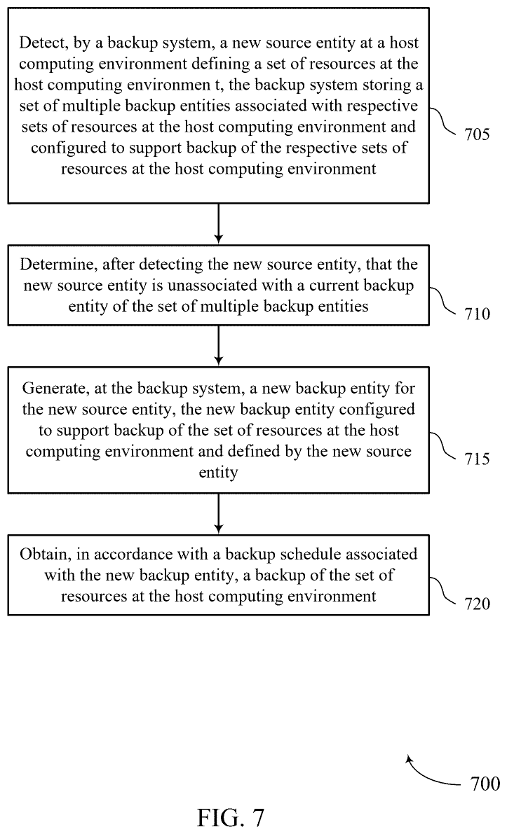

FIG. 7 shows a flowchart illustrating a method 700 that supports automatic creation of backup entities in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include detecting, by a backup system, a new source entity at a host computing environment defining a set of resources at the host computing environment, the backup system storing a set of multiple backup entities associated with respective sets of resources at the host computing environment and configured to support backup of the respective sets of resources at the host computing environment. The operations of 705 may be performed in accordance with examples as disclosed herein. In some examples, aspects of the operations of 705 may be performed by a source entity detection component 525 as described with reference to FIG. 5.

At 710, the method may include determining, after detecting the new source entity, that the new source entity is unassociated with a current backup entity of the set of multiple backup entities. The operations of 710 may be performed in accordance with examples as disclosed herein. In some examples, aspects of the operations of 710 may be performed by a source entity processor 530 as described with reference to FIG. 5.

At 715, the method may include generating, at the backup system, a new backup entity for the new source entity, the new backup entity configured to support backup of the set of resources at the host computing environment and defined by the new source entity. The operations of 715 may be performed in accordance with examples as disclosed herein. In some examples, aspects of the operations of 715 may be performed by a backup entity generation component 535 as described with reference to FIG. 5.

At 720, the method may include obtaining, in accordance with a backup schedule associated with the new backup entity, a backup of the set of resources at the host computing environment. The operations of 720 may be performed in accordance with examples as disclosed herein. In some examples, aspects of the operations of 720 may be performed by a backup data interface 540 as described with reference to FIG. 5.

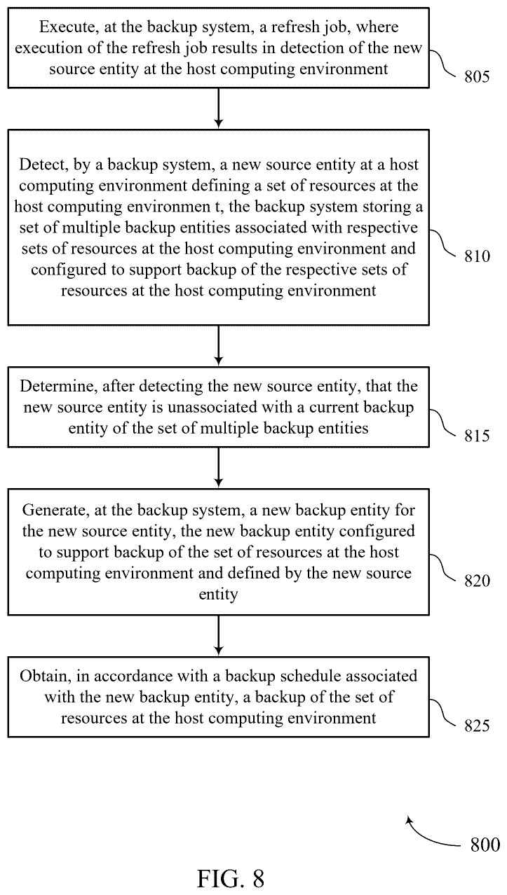

FIG. 8 shows a flowchart illustrating a method 800 that supports automatic creation of backup entities in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include executing, at the backup system, a refresh job, where execution of the refresh job results in detection of the new source entity at the host computing environment. The operations of 805 may be performed in accordance with examples as disclosed herein. In some examples, aspects of the operations of 805 may be performed by a refresh execution component 545 as described with reference to FIG. 5.

At 810, the method may include detecting, by a backup system, a new source entity at a host computing environment defining a set of resources at the host computing environment, the backup system storing a set of multiple backup entities associated with respective sets of resources at the host computing environment and configured to support backup of the respective sets of resources at the host computing environment. The operations of 810 may be performed in accordance with examples as disclosed herein. In some examples, aspects of the operations of 810 may be performed by a source entity detection component 525 as described with reference to FIG. 5.

At 815, the method may include determining, after detecting the new source entity, that the new source entity is unassociated with a current backup entity of the set of multiple backup entities. The operations of 815 may be performed in accordance with examples as disclosed herein. In some examples, aspects of the operations of 815 may be performed by a source entity processor 530 as described with reference to FIG. 5.

At 820, the method may include generating, at the backup system, a new backup entity for the new source entity, the new backup entity configured to support backup of the set of resources at the host computing environment and defined by the new source entity. The operations of 820 may be performed in accordance with examples as disclosed herein. In some examples, aspects of the operations of 820 may be performed by a backup entity generation component 535 as described with reference to FIG. 5.

At 825, the method may include obtaining, in accordance with a backup schedule associated with the new backup entity, a backup of the set of resources at the host computing environment. The operations of 825 may be performed in accordance with examples as disclosed herein. In some examples, aspects of the operations of 825 may be performed by a backup data interface 540 as described with reference to FIG. 5.

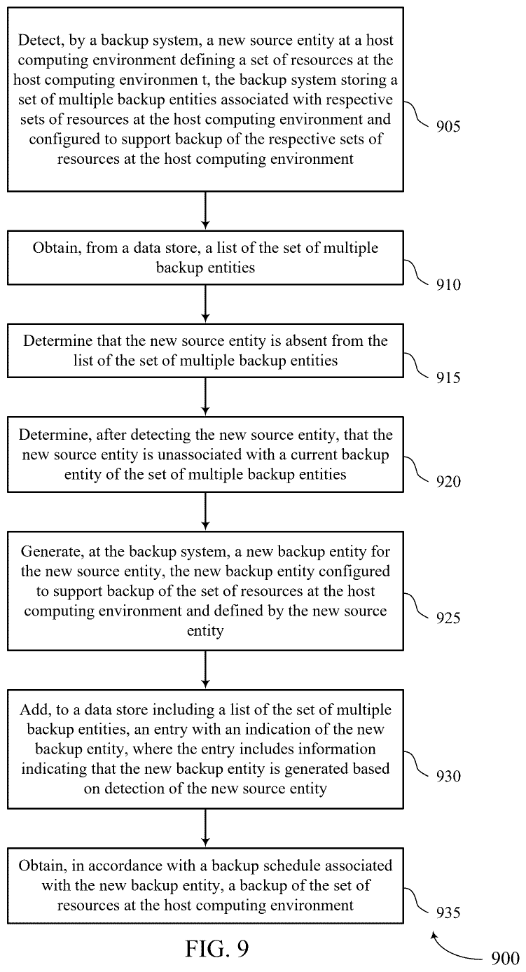

FIG. 9 shows a flowchart illustrating a method 900 that supports automatic creation of backup entities in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include detecting, by a backup system, a new source entity at a host computing environment defining a set of resources at the host computing environment, the backup system storing a set of multiple backup entities associated with respective sets of resources at the host computing environment and configured to support backup of the respective sets of resources at the host computing environment. The operations of 905 may be performed in accordance with examples as disclosed herein. In some examples, aspects of the operations of 905 may be performed by a source entity detection component 525 as described with reference to FIG. 5.

At 910, the method may include obtaining, from a data store, a list of the set of multiple backup entities. The operations of 910 may be performed in accordance with examples as disclosed herein. In some examples, aspects of the operations of 910 may be performed by a source entity processor 530 as described with reference to FIG. 5.

At 915, the method may include determining that the new source entity is absent from the list of the set of multiple backup entities. The operations of 915 may be performed in accordance with examples as disclosed herein. In some examples, aspects of the operations of 915 may be performed by a source entity processor 530 as described with reference to FIG. 5.

At 920, the method may include determining, after detecting the new source entity, that the new source entity is unassociated with a current backup entity of the set of multiple backup entities. The operations of 920 may be performed in accordance with examples as disclosed herein. In some examples, aspects of the operations of 920 may be performed by a source entity processor 530 as described with reference to FIG. 5.

At 925, the method may include generating, at the backup system, a new backup entity for the new source entity, the new backup entity configured to support backup of the set of resources at the host computing environment and defined by the new source entity. The operations of 925 may be performed in accordance with examples as disclosed herein. In some examples, aspects of the operations of 925 may be performed by a backup entity generation component 535 as described with reference to FIG. 5.

At 930, the method may include adding, to a data store including a list of the set of multiple backup entities, an entry with an indication of the new backup entity, where the entry includes information indicating that the new backup entity is generated based on detection of the new source entity. The operations of 930 may be performed in accordance with examples as disclosed herein. In some examples, aspects of the operations of 930 may be performed by a backup entity generation component 535 as described with reference to FIG. 5.

At 935, the method may include obtaining, in accordance with a backup schedule associated with the new backup entity, a backup of the set of resources at the host computing environment. The operations of 935 may be performed in accordance with examples as disclosed herein. In some examples, aspects of the operations of 935 may be performed by a backup data interface 540 as described with reference to FIG. 5.

The following provides an overview of aspects of the present disclosure:

Aspect 1: A method, comprising: detecting, by a backup system, a new source entity at a host computing environment defining a set of resources at the host computing environment, the backup system storing a plurality of backup entities associated with respective sets of resources at the host computing environment and configured to support backup of the respective sets of resources at the host computing environment; determining, after detecting the new source entity, that the new source entity is unassociated with a current backup entity of the plurality of backup entities; generating, at the backup system, a new backup entity for the new source entity, the new backup entity configured to support backup of the set of resources at the host computing environment and defined by the new source entity; and obtaining, in accordance with a backup schedule associated with the new backup entity, a backup of the set of resources at the host computing environment.

Aspect 2: The method of aspect 1, further comprising: executing, at the backup system, a refresh job, wherein execution of the refresh job results in detection of the new source entity at the host computing environment.

Aspect 3: The method of any of aspects 1 through 2, wherein determining that the new source entity is unassociated with the current backup entity comprises: obtaining, from a data store, a list of the plurality of backup entities; and determining that the new source entity is absent from the list of the plurality of backup entities.

Aspect 4: The method of any of aspects 1 through 3, wherein generating the new backup entity comprises: adding, to a data store comprising a list of the plurality of backup entities, an entry with an indication of the new backup entity, wherein the entry includes information indicating that the new backup entity is generated based on detection of the new source entity.

Aspect 5: The method of aspect 4, wherein the entry comprises a name for the new backup entity, the name is generated based at least in part on an identifier for the new source entity.

Aspect 6: The method of any of aspects 1 through 5, wherein the backup schedule associated with the new backup entity is a default backup schedule associated with the host computing environment.

Aspect 7: The method of any of aspects 1 through 6, further comprising: receiving, at a user interface of the backup system, a user input that enables generation of new backup entities for new source entities, wherein the new backup entity is generated based at least in part on the user input.

Aspect 8: The method of any of aspects 1 through 7, further comprising: receiving, at a user interface of the backup system, one or more user inputs that define one or more resources of the set of resources of the new source entity, wherein the backup is obtained for the one or more resources that are defined by the one or more user inputs.

Aspect 9: The method of any of aspects 1 through 8, further comprising: determining that a backup entity of the plurality of backup entities is unassociated with an existing source entity at the host computing environment; and archiving, based at least in part on determining that the backup entity is unassociated with an existing source entity, the backup entity without deleting a second backup associated with the backup entity.

Aspect 10: The method of any of aspects 1 through 9, wherein the host computing environment comprises a cluster of computing nodes that support one or more containerized applications and the new source entity comprises a new namespace at the cluster of computing nodes.

Aspect 11: An apparatus comprising one or more memories storing processor-executable code, and one or more processors coupled with the one or more memories and individually or collectively operable to execute the code to cause the apparatus to perform a method of any of aspects 1 through 10.

Aspect 12: An apparatus comprising at least one means for performing a method of any of aspects 1 through 10.

Aspect 13: A non-transitory computer-readable medium storing code the code comprising instructions executable by one or more processors to perform a method of any of aspects 1 through 10.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
receiving, in a user interface of a backup system, user input comprising an indication for automatically creating backup entities for new source entities lacking an association to a current backup entity, the backup system storing a plurality of backup entities associated with respective sets of resources at a host computing environment and configured to support backup of the respective sets of resources at the host computing environment;
executing, by the backup system and based at least in part on the user input, a refresh job for detecting the new source entities lacking an association to the current backup entity;
detecting, by the backup system, a new source entity at the host computing environment, the new source entity defining a set of resources at the host computing environment;
determining, after detecting the new source entity, that the new source entity is unassociated with the current backup entity of the plurality of backup entities;
generating, at the backup system and based on the determining that the new source entity is unassociated with the current backup entity of the plurality of backup entities, a new backup entity for the new source entity, the new backup entity configured to support backup of the set of resources at the host computing environment and defined by the new source entity; and
obtaining, in accordance with a backup schedule associated with the new backup entity, a backup of the set of resources at the host computing environment.

2. The method of claim 1, wherein obtaining the backup of the set of resources at the host computing environment comprises:
receiving, in the user interface, user input comprising an adjustment to the set of resources defined by the new source entity; and
obtaining the backup of the set of resources in accordance with the adjustment.

3. The method of claim 1, wherein determining that the new source entity is unassociated with the current backup entity comprises:
obtaining, from a data store, a list of the plurality of backup entities; and
determining that the new source entity is absent from the list of the plurality of backup entities.

4. The method of claim 1, wherein generating the new backup entity comprises:
adding, to a data store comprising a list of the plurality of backup entities, an entry with an indication of the new backup entity, wherein the entry comprises an association of the backup schedule of the new source entity with the new backup entity.

5. The method of claim 4, wherein:
the entry comprises a name for the new backup entity,
the name is generated based at least in part on an identifier for the new source entity.

6. The method of claim 1, wherein the backup schedule associated with the new backup entity is a default backup schedule associated with the host computing environment.

7. (canceled)

8. The method of claim 1, further comprising:
receiving, at the user interface of the backup system, one or more second user inputs that define one or more resources of the set of resources of the new source entity, wherein the backup is obtained for the one or more resources that are defined by the one or more second user inputs.

9. The method of claim 1, further comprising:
determining that a backup entity of the plurality of backup entities is unassociated with an existing source entity at the host computing environment; and
archiving, based at least in part on determining that the backup entity is unassociated with an existing source entity, the backup entity without deleting a second backup associated with the backup entity.

10. The method of claim 1, wherein:
the host computing environment comprises a cluster of computing nodes that support one or more containerized applications, and
the new source entity comprises a new namespace at the cluster of computing nodes.

11. An apparatus, comprising:
one or more memories storing processor-executable code; and
one or more processors coupled with the one or more memories and individually or collectively operable to execute the code to cause the apparatus to:
receive, in a user interface of a backup system, user input comprising an indication for automatically creating backup entities for new source entities lacking an association to a current backup entity, the backup system storing a plurality of backup entities associated with respective sets of resources at a host computing environment and configured to support backup of the respective sets of resources at the host computing environment;
execute, by the backup system and based at least in part on the user input, a refresh job for detecting the new source entities lacking an association to the current backup entity;
detect, by the backup system, a new source entity at the host computing environment, the new source entity defining a set of resources at the host computing environment;
determine, after detecting the new source entity, that the new source entity is unassociated with the current backup entity of the plurality of backup entities;
generate, at the backup system and based on determining that the new source entity is unassociated with the current backup entity of the plurality of backup entities, a new backup entity for the new source entity, the new backup entity configured to support backup of the set of resources at the host computing environment and defined by the new source entity; and
obtain, in accordance with a backup schedule associated with the new backup entity, a backup of the set of resources at the host computing environment.

12. The apparatus of claim 11, wherein to obtain the backup of the set of resources at the host computing environment, the one or more processors are individually or collectively further operable to execute the code to cause the apparatus to:
receive, in the user interface, user input comprising an adjustment to the set of resources defined by the new source entity; and
obtain the backup of the set of resources in accordance with the adjustment.

13. The apparatus of claim 11, wherein, to determine that the new source entity is unassociated with the current backup entity, the one or more processors are individually or collectively operable to execute the code to cause the apparatus to:
obtain, from a data store, a list of the plurality of backup entities; and
determine that the new source entity is absent from the list of the plurality of backup entities.

14. The apparatus of claim 11, wherein, to generate the new backup entity, the one or more processors are individually or collectively operable to execute the code to cause the apparatus to:
add, to a data store comprising a list of the plurality of backup entities, an entry with an indication of the new backup entity, wherein the entry comprises an association of the backup schedule of the new source entity with the new backup entity.

15. The apparatus of claim 14, wherein:
the entry comprises a name for the new backup entity, and
the name is generated based at least in part on an identifier for the new source entity.

16. A non-transitory computer-readable medium storing code, the code comprising instructions executable by one or more processors to:
receive, in a user interface of a backup system, user input comprising an indication for automatically creating backup entities for new source entities lacking an association to a current backup entity, the backup system storing a plurality of backup entities associated with respective sets of resources at a host computing environment and configured to support backup of the respective sets of resources at the host computing environment;
execute, by the backup system and based at least in part on the user input, a refresh job for detecting the new source entities lacking an association to the current backup entity;
detect, by the backup system, a new source entity at the host computing environment, the new source entity defining a set of resources at the host computing environment;
determine, after detecting the new source entity, that the new source entity is unassociated with the current backup entity of the plurality of backup entities;
generate, at the backup system and based on determining that the new source entity is unassociated with the current backup entity of the plurality of backup entities, a new backup entity for the new source entity, the new backup entity configured to support backup of the set of resources at the host computing environment and defined by the new source entity; and
obtain, in accordance with a backup schedule associated with the new backup entity, a backup of the set of resources at the host computing environment.

17. The non-transitory computer-readable medium of claim 16, wherein to obtain the backup of the set of resources at the host computing environment, the instructions are further executable by the one or more processors to:
receive, in the user interface, user input comprising an adjustment to the set of resources defined by the new source entity; and
obtain the backup of the set of resources in accordance with the adjustment.

18. The non-transitory computer-readable medium of claim 16, wherein the instructions to determine that the new source entity is unassociated with the current backup entity are executable by the one or more processors to:
obtain, from a data store, a list of the plurality of backup entities; and
determine that the new source entity is absent from the list of the plurality of backup entities.

19. The non-transitory computer-readable medium of claim 16, wherein the instructions to generate the new backup entity are executable by the one or more processors to:
add, to a data store comprising a list of the plurality of backup entities, an entry with an indication of the new backup entity, wherein the entry comprises an association of the backup schedule of the new source entity with the new backup entity.

20. The non-transitory computer-readable medium of claim 19, wherein:
the entry comprises a name for the new backup entity, and
the name is generated based at least in part on an identifier for the new source entity.
